(19) United States
(12) Patent Application Publication
(10) Pub. No.: US 2007/0236001 A1
(43) Pub. Date: Oct. 11, 2007

(54) Set of sheets

(75) Inventors: Oliviero Dolci, Milano (IT); Emanuela Moltani, San Felice Segrate (IT); Michael Morris, Norwalk, CT (US)

Correspondence Address: KATTEN MUCHIN ROSENMAN LLP, 575 MADISON AVENUE, NEW YORK, NY, 10022-2585, US

(73) Assignee: Happy Books SRL

(21) Appl. No.: 11/724,814

(22) Filed: Mar. 16, 2007

(30) Foreign Application Priority Data
Mar. 24, 2006 (IT) MI2006U000107

(51) Int. Cl. B42D 1/00

(52) U.S. Cl. 281/38

(57) ABSTRACT

A sheet of sheets comprises individual sheets (1a-1g) which can be placed on top of each other and which have a predefined shape; each individual sheet (1a-1g) comprises furthermore a first portion (12, 14, 16, 18, 20, 24) in the form of a subject and associated with a second portion (26, 28, 30, 32, 34, 36 and 38) containing information; for children and adolescent users, the selection and arrangement on top of each other of these individual sheets, stimulated by the graphic motifs shown on them, is entertaining and instructive.

The present invention relates to a set of sheets.

More specifically the invention relates to a set of sheets which can be arranged on top of each other for amusement and educational purposes, being intended for children and adolescent users.

It is known that sets of ordered sheets of considerable thickness are used in the production of children's books in order to ensure good strength and rigidity able to withstand the stresses applied to them by this particular category of user.

For this purpose, the sheets are usually made of cardboard, paperboard, plastic, wood or some other similar material so that, in addition to thickness and rigidity, a perfectly flat condition is also ensured.

The sheets, moreover, must have a pleasing and attractive appearance; for this reason, those which are commercially distributed—usually bound in the form of a book—have perimetral edges of the most widely shapes so that the set of ordered sheets may assume the shape of characters, animals, vehicles or the most varied objects and subjects which may be particularly attractive for children.

Another important requirement relates to the three-dimensional nature of the sets of sheets; the Applicant, in the past, has developed a product consisting of a set of sheets ordered in the manner of a book on top of each other, where it is envisaged that each sheet has a volume in plan view contained within the shape of the underlying sheet and containing the shape of the sheet situated immediately above.

This product is protected by the U.S. Pat. No. 5,901,983. Owing to the thickness of each sheet, the set of sheets ordered in a book provides a notable three-dimensional effect, also on account of the particular continuity of the graphic motifs shown on the visible surfaces of the said sheets. As a result of this notable three-dimensional effect, the child is able to regard also the book as a game.

Another constructional solution is illustrated in European Patent No. 1057508.

In this case the form of the individual sheets is such as to give the impression of a three-dimensional effect when observing the set of sheets bound in the form of a book, from both sides.

Moreover the binding provides a support base so that the set of sheets no longer need be necessarily rested on a surface parallel to that of the said sheets, and the three-dimensional effect is therefore increased.

In all these solutions, the individual sheets have or may have information which is written on one or both the sides, which information may be easily accessed by leafing through the set of sheets in the same way as a book.

It would be desirable to have available a set of sheets which, while maintaining the three-dimensional effect characteristic of the prior solutions and in particular of the product of U.S. Pat. No. 5,901,983, does not necessarily require binding in the form of a book and provides written information which can be accessed immediately, sheet by sheet, without the need for any manipulation.

A further more specific object is that of providing a set of sheets able to stimulate in the child learning through the recognition, ordering and arrangement of the various sheets, whilst ensuring the glossy appearance of the article. This object is achieved with a set of sheets which can be arranged on top of each other, each sheet having a contour with a predefined shape, characterized in that each sheet comprises a first portion shaped in the manner of at least part of a three-dimensional subject and associated with a second portion displaying information in the form of graphic symbols.

The characteristic features and advantages of the present invention will become clear from the description, provided hereinbelow, of an example of embodiment thereof, provided by way of a non-limiting illustration with reference to the accompanying drawings in which:

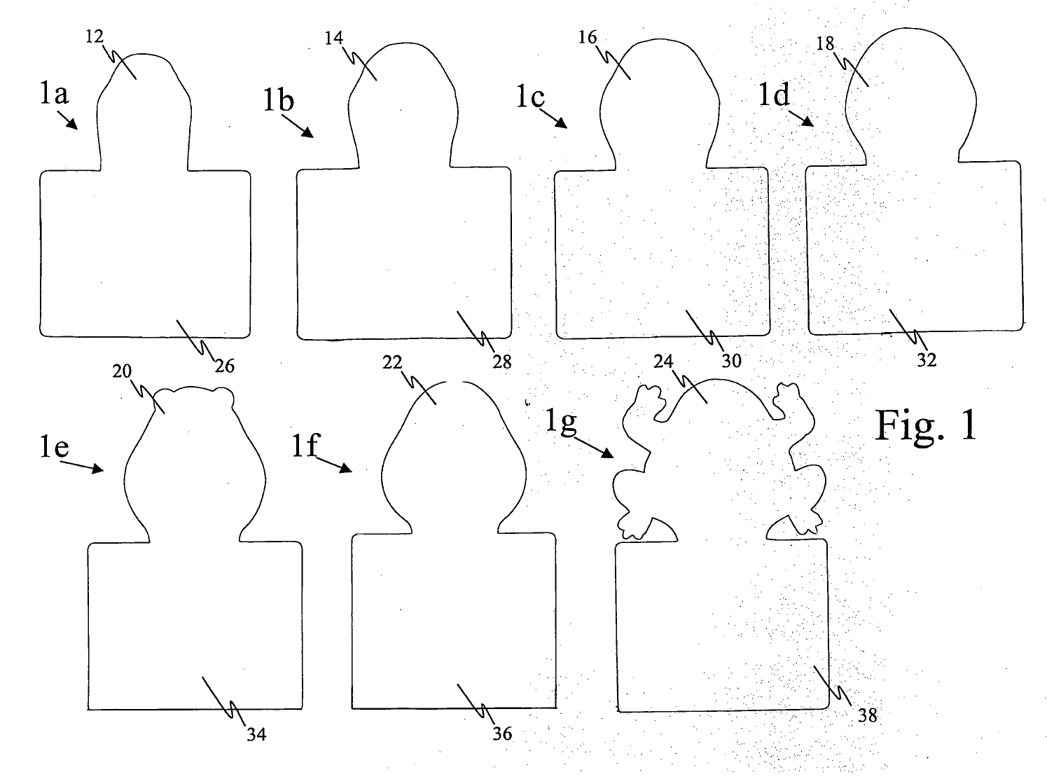

The set of FIGS. 1a-1g shows separate plan views of sheets which can be arranged on top of each other, according to the present invention;

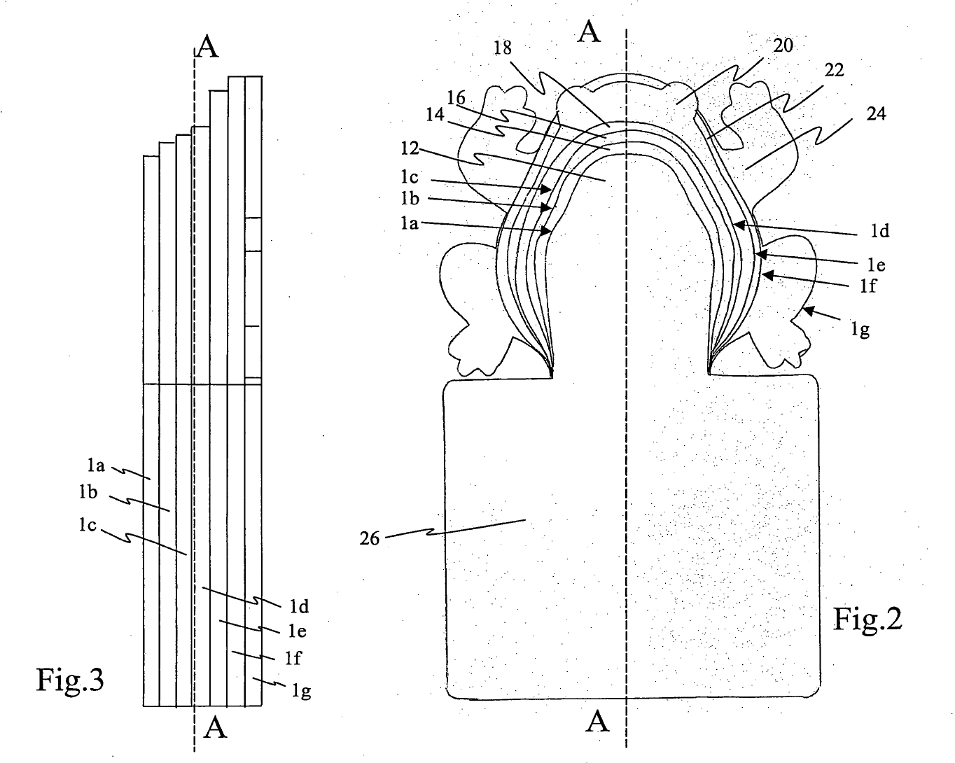

FIG. 2 shows a schematic plan view of a set of sheets arranged on top of each, according to the invention;

FIG. 3 shows a side view of the set of sheets arranged on top of each other, according to the invention;

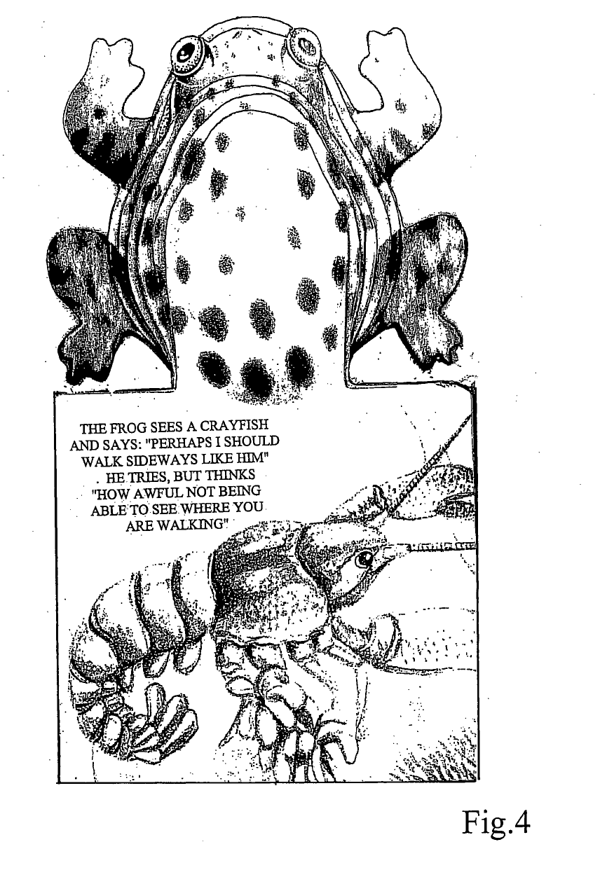

FIG. 4 shows the plan view of FIG. 2, provided with graphic effects, according to the invention.

With reference to these Figures, FIG. 1 shows sheets numbered from 1a to 1g with different shapes and sizes; all together they form a set of sheets, according to the invention.

As already mentioned, these sheets are usually made of cardboard, paperboard, plastic, wood or other similar material so that, apart from thickness and rigidity, a perfectly flat arrangement is also ensured.

Alternatively, the sheets may also be made of non-rigid material (for example fabric) with which a stiffening element is combined.

Advantageously, the sheets 1a to 1g comprise respective first portions 12, 14, 16, 18, 20, 22 and 24 which have partial or complete forms of sections of a subject (a frog in the particular case of FIG. 1) and respective second portions 26, 28, 30, 34, 36, 38 with graphic symbols, where, in the remainder of the description, “graphic symbols” is understood as meaning generally information, figures or the like.

The first and the second portions are physically connected and belong to a single sheet, although they have different and independent forms.

More generally, according to the invention, the first portions 12, 14, 16, 18, 20, 22 and 24 may represent partially or completely, both with their form and the image displayed, animals or alternatively, they may represent partially or completely other types of subjects.

The images reproduced on the first portions of the various sheets represent different sections of a complete three-dimensional figure, such as that of a frog shown in FIGS. 2 and 4.

We can imagine that the frog has been ideally sectioned along several parallel planes, in the direction A-A, shown in FIGS. 4 and 5. Each of the parallel sections obtained corresponds to one of the first portions 12, 14, 16, 18, 20, 22 and 24 of the respective sheets 1a to 1g of the set of sheets, according to the invention.

In particular, the portion 12 of the sheet 1a shows a plan view of a section closest to the top of the frog's body, which is also that with the smallest area. The successive first portions 14, 16, 18, 20, 22 and 24 show plan views of other sections of the frog, parallel to the portion 12 of the sheet 1a, obtained as one gradually moves away from the top of the frog's body towards its feet.

Sections formed along planes situated gradually further away from the top of the frog's body correspond, in the case of the first portions, to increasingly broader shapes and increasingly bigger surfaces.

The particular shapes and surfaces of the first portions 12, 14, 16, 18, 20, 22 and 24 of the sheets 1a to 1g are such that the sheets can be arranged on top of each in any order, but allow a correct overall view of the frog in three dimensions and a continuity of the drawings reproduced on the visible surfaces of the said sheets, while keeping the first portion 24 of the sheet 1g in the bottom position and gradually arranging on top the portions 22, 20, 18, 16, 14, 12 of the sheets 1f to 1a.

In general, the same applies to the case where the images reproduced on the first portions relate to other subjects.

The first portions differ in terms of shape and size for example because they may have protuberances which represent features of parts of the subjects shown; these peculiar features of the images shown help the child to find the correct order for positioning of the sheets and construct the correct final three-dimensional image.

The various shapes, dimensions and any protuberances of the first portions 12, 14, 16, 18, 20, 22 and 24 help the child with visual learning by means of observation and recognition of the image reproduced, encouraging him or her to try to understand the correct position of the sheet within the set of sheets 1a to 1g. The child is thus stimulated to try to arrange the sheets on top of each other so as to obtain an overall visual effect which simulates the three-dimensional appearance of the subject.

FIG. 2 shows an overall view of the sheets arranged on top of each other in exact order, where all the first portions 12, 14, 16, 18, 20 and 24 are also visible.

FIG. 4 shows, instead, the same overall view provided also with examples of graphic motifs.

The second portions 26, 28, 30, 32, 34, 36 and 38, on the other hand, although they may also have images, are mainly provided with text having a narrative or informative content, such as messages and/or information and/or short stories and/or questions or quiz games and have the function of stimulating learning on the part of the child, if necessary by means of the guided reading of the image shown on the first portions 12, 14, 16, 18, 20, 22 and 24.

The contour of these second portions is usually polygonal, in particular rectangular;

alternatively, however, it could also have a substantially circular form in the view of the visual effect which the first and second portions may ensure in combination.

According to the invention the sheets may be provided with graphic motifs or text on both the sides; the graphic motifs present essentially on the first portion on one side may differ from those present on the other side, for example as regards colour or specific details, while obviously having to maintain the same shape as the subject represented.

Differently, the graphic symbols reproduced on the second portions may vary from one side to the other, the second portions being not bound to any one particular shape.

Modifications and variations which are conceptually and/or structurally equivalent are possible and may be envisaged, albeit remaining within the scope of the invention.

For example, the first and the second portion could be joined together in a non-permanent manner, namely removably, so as to allow interchangeability between the subjects shown on the first portions and the graphic symbols reproduced on the second portions.

Alternatively, the second portion could comprise a plurality of sheets with the same design as a note pad or a block of so-called “post-it” stickers, allowing the user to write comments or answers to questions and the like.

By way of a further alternative, the set of sheets could have the structure described in the already mentioned European patent No. 1057508, namely with a three-dimensional effect which can be obtained when observing the set of sheets from both ends. In other words, the set of sheets comprises a first set of sheets increasing in size from a first end towards the midway point of the said set and a second set of sheets decreasing in size from this midway point towards a second end.

1. Set of sheets (1a-1g) which can be arranged on top of each other, each sheet having a contour with a predefined shape and a plan-view volume which is greater or smaller than respectively, but partly coincides substantially with, a sheet which can be arranged on top of or underneath it,
characterized in that each sheet (1a-1g) comprises a first portion (12, 14, 16, 18, 20, 22, 24) shaped in the manner of at least part of a three-dimensional subject associated with a second portion (26, 28, 30, 32, 34, 36 and 38) containing information in the form of graphic symbols.

2. Set of sheets (1a-1g) which can be arranged on top of each other according to claim 1, in which the first portions (12, 14, 16, 18, 20, 22, 24) and the second portions (26, 28, 30, 32, 34, 36 and 38) are connected, but have different forms and are independent.

3. Set of sheets (1a-1g) which can be arranged on top of each other according to claim 2, in which the first portions (12, 14, 16, 18, 20, 22, 24) have a contour connected solely along a small part to the second portions (26, 28, 30, 32, 34, 36 and 38).

4. Set of sheets (1a-1g) which can be arranged on top of each other according to claim 2, in which the first portions (12, 14, 16, 18, 20, 22, 24) and the second portions (26, 28, 30, 32, 34, 36 and 38) are removably connected so as to allow interchangeability between the subjects shown on the first portions and the graphic symbols reproduced on the second portions.

5. Set of sheets (1a-1g) according to claim 1, in which, in the set of sheets correctly ordered, the first portions (12, 14, 16, 18, 20, 22, 24) provide an overall three-dimensional view of the subject.

6. Set of sheets (1a-1g) according to claim 5, comprising a first set of sheets increasing in size from a first end towards the midway point of the said set and a second set of sheets decreasing in size from this midway point, towards a second end, so as to ensure a three-dimensional effect when observing the set of sheets from both the ends.

7. Set of sheets (1a-1g) according to claim 1, in which images of the subjects of the first portions (12, 14, 16, 18, 20, 22, 24) and the graphic symbols of the second portions (26, 28, 30, 32, 34, 36 and 38) are present on both the sides of the sheets.

8. Set of sheets (1a-1g) according to claim 1, in which the second portions (26, 28, 30, 32, 34, 36 and 38) comprise a plurality of sheets organized in the form of a note pad.

9. Set of sheets (1a-1g) according to claim 1, in which the second portions (26, 28, 30, 32, 34, 36 or 38) comprise a plurality of sheets organized in the form of a block of “post-it” stickers.

10. Set of sheets (1a-1g) according to claim 1, in which at least one of the first portions (12, 14, 16, 18, 20, 22, 24) has protuberances determined by the form of at least part of the subject shown on it.

11. Set of sheets (1a-1g) according to claim 1, in which the second portions (26, 28, 30, 32, 34, 36 and 38) have a contour which is substantially polygonal.

12. Set of sheets (1a-1g) according to claim 1, in which the second portions (26, 28, 30, 32, 34, 36 and 38) have a rectangular contour.

13. Set of sheets (1a-1g) according to claim 1, in which the second portions (26, 28, 30, 32, 34, 36 and 38) have a substantially circular contour.

14. Set of sheets (1a-1g) according to claim 1, in which the second portion (26, 28, 30, 32, 34, 36 and 38) shows images of animals, accompanied by a short story.
